(19) United States
(12) Patent Application Publication
(10) Pub. No.: US 2011/0253322 A1
(43) Pub. Date: Oct. 20, 2011

(54) FOLDAWAY SECURITY SHUTTER

(76) Inventor: Marco Fanizzi, Conversano (BA) (IT)

(21) Appl. No.: 13/141,779

(22) PCT Filed: Dec. 17, 2009
(86) PCT No.: PCT/EP09/67429

§ 371 Date: Jun. 23, 2011

(30) Foreign Application Priority Data
Dec. 24, 2008 (IT) MI 2008A 002324

(51) Int. Cl. E06B 9/06; E05F 15/08; E05F 11/02

(52) U.S. Cl. 160/188; 160/405

(57) ABSTRACT

A foldaway security shutter (1) is described, comprising a plurality of transverse elements (2) articulated together by means of connecting-rods (3) pivoted at the ends (4) of said transverse elements (2), two lateral uprights (6) within which the ends (4) of the transverse elements (2) and the connecting-rods (3) slide between a closed position in which said transverse elements (2) extend along the uprights (6) and an open position in which the transverse elements (2) are gathered in an upper box (8), and operating means (7) for the transverse elements (2). Said operating means (7) are equipped with a toothed wheel (9) operated by an electric motor (17), suitable for engaging the internal teeth (10) of rack connecting-rods (3), causing the upward or downward movement of the transverse elements (2).

The present invention concerns a foldaway security shutter, of the anti-intrusion type for example used for securing openings such as windows of private dwellings, shops or business premises in general.

The term ‘shutter’ here refers to the type of grille or roller-door made up of a series of articulated horizontal transverse parallel elements whose ends slide in two lateral guides, typically vertical, and are folded away usually at the top of the shutter in a box housing a cantilever of folded elements, freeing the opening.

The known art comprises similar windable sectional shutters, for example of the type where the transverse elements are driven by pulley-and belt or sprocket-and-chain systems contained in the uprights, controlled by an electric motor.

From the mechanical point of view, such solution has the disadvantage that the transverse elements are substantially stressed in compression, with a more serious risk of putting them out of square.

The security of said movement system is also disadvantageous: since the chain or the belt runs the entire length of the upright all the way to the base (an idler pulley or sprocket is in fact necessary), it is simple to get access to the control components, with considerable risks for non-expert technicians.

In addition the noise generated by the movement of the chain or the belt is irritating and increases over time as a result of friction which accelerates the wear on the shutter. Another source of noise in known movement systems is represented by known devices for restraining the bars in the elastic type of folding-box (due to movement of the springs). Said devices necessitate routine maintenance as the springs are subject to wear.

An object of the present invention is therefore to create a foldaway shutter with a winding mechanism that is more efficient, less noisy, less subject to wear and easy to manufacture.

In accordance with the invention, this object is achieved with a foldaway security shutter comprising a plurality of transverse elements articulated together by means of connecting-rods pivoted at the ends of said transverse elements, two lateral uprights between which the ends of the transverse elements and the connecting-rods slide between a closed position in which said transverse elements extend along the uprights and an open position in which the transverse elements are gathered in an upper box, and operating means for the transverse elements, characterised in that the box houses a horizontal inferior guide provided with a plurality of consecutive notches suitable for the temporary anelastic retainment of transversal elements.

These and other characteristics of the present invention will be made more clearly evident from the following detailed description of an example of a practical embodiment thereof, illustrated without limiting effect in the attached drawings, in which:

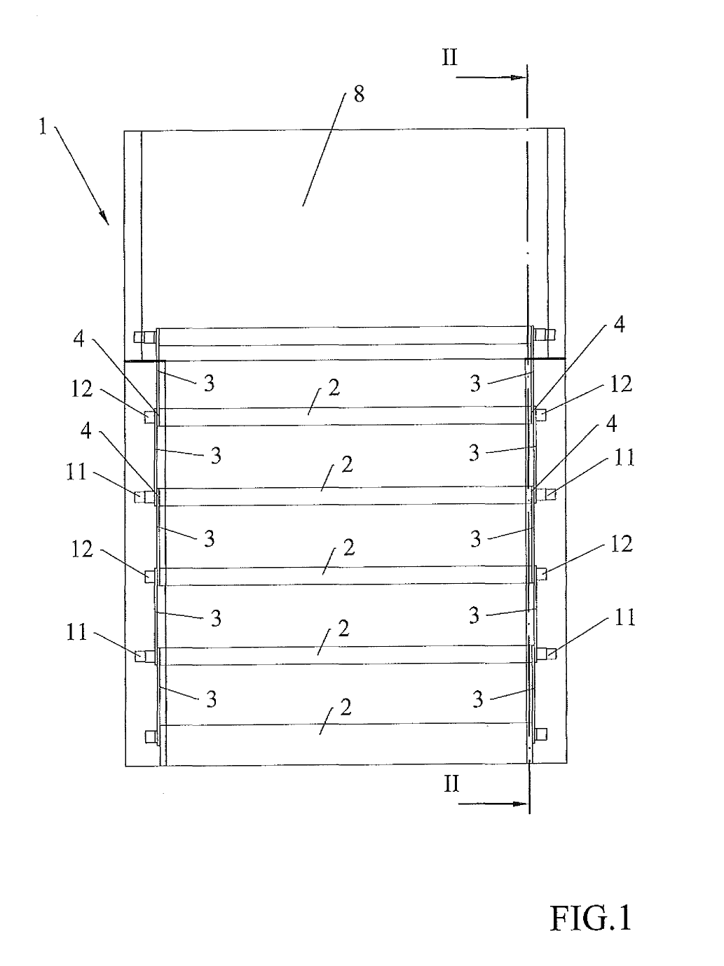

FIG. 1 shows a frontal view of the shutter in the closed position;

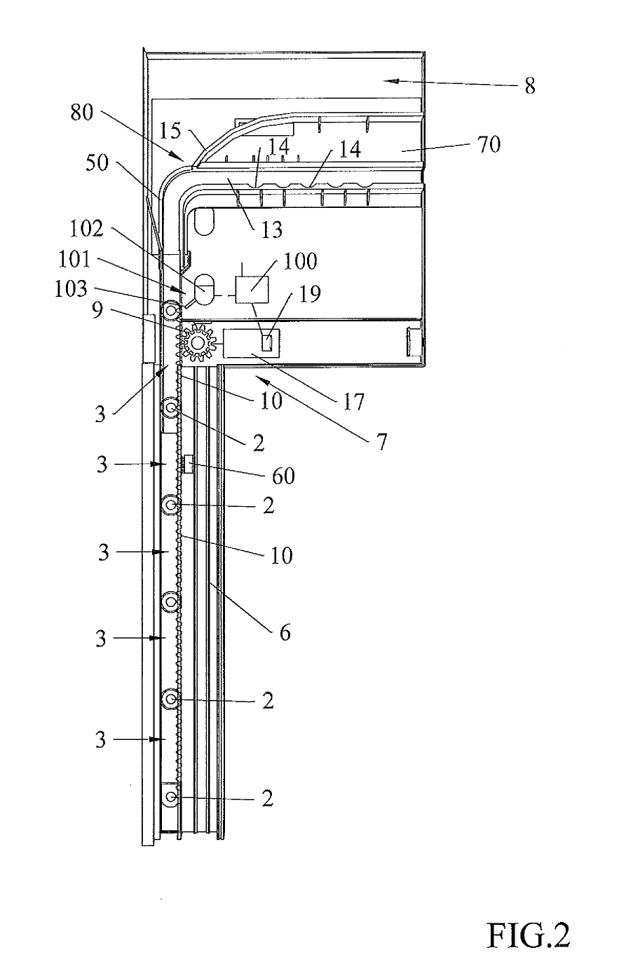

FIG. 2 shows a view in section along the line II-II in FIG. 1;

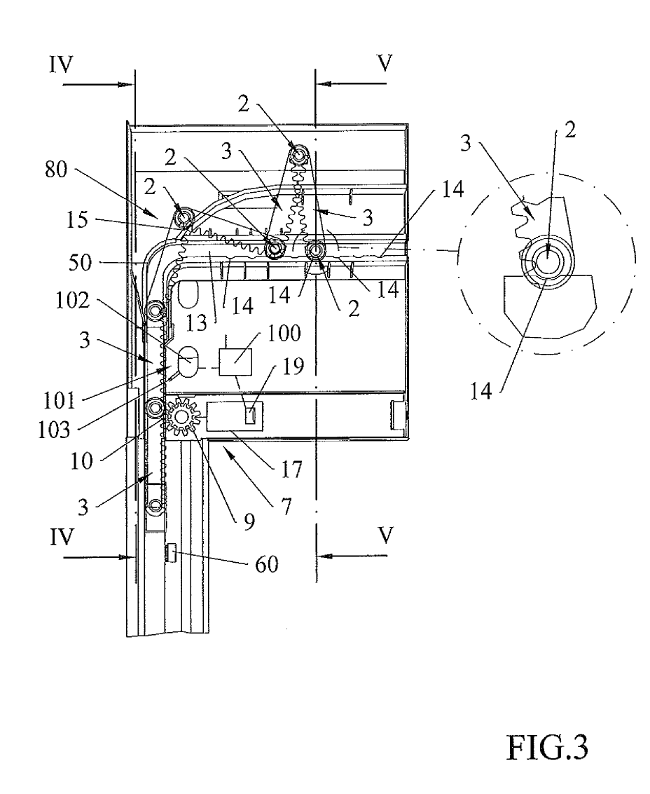

FIG. 3 shows the section shown in FIG. 2 with the shutter in the open position;

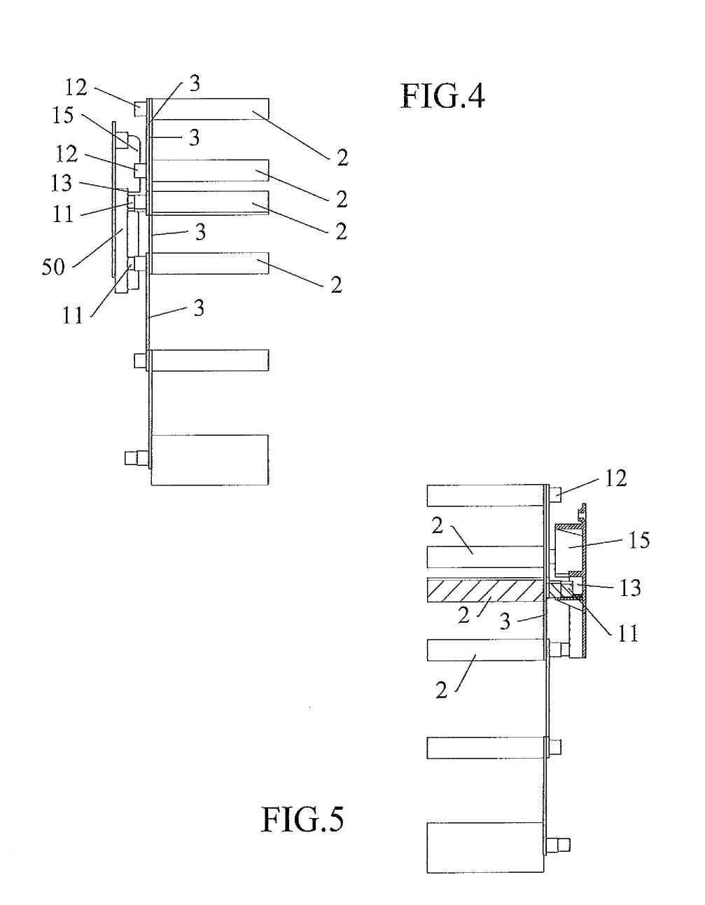

FIG. 4 shows a view in section along the line IV-IV in FIG. 3;

FIG. 5 shows a view in section along the line V-V in FIG. 3.

With reference to FIG. 1 we note a shutter 1 with an upper box 8 and a roller-door 5 consisting of a plurality of transverse horizontal elements 2, typically steel bars, and rack connecting-rods 3 pivoted at the ends 4 of the bars 2 to form an articulated roller-door 5. The connecting-rods 3 may also be noted in FIG. 2, with reference to which we may take note of the concatenation of the connecting-rods 3 in the configuration with roller-door 5 closed.

The bars 2 have at their ends alternately long guide pins 11 and short guide pins 12, whose function will be clarified below.

The ends 4 of bars 2 and the relative joining rods 3 slide along two lateral uprights 6 located in a vertical position, between a closed position of roller-door 5 (FIGS. 1-2) and an open position of roller-door 5 (FIG. 3) in which the bars 2 and the connecting-rods 3 are folded up into box 8. Brushes 60 are provided in the uprights 6 for cleaning the teeth 10 of connecting-rods 3.

In FIGS. 2 and 3 we note operating means 7 located above the base of box 8, comprising an electric motor 17 suitable for operating a toothed wheel 9 (FIGS. 2 and 4) which meshes with the teeth 10 of rack connecting-rods 3.

The two lateral uprights 6 are in communication by means of connectors 50, each with a lower guide 13 equipped with a plurality of recesses 14 capable of temporarily detaining the bars with the long guide pin 11 (FIGS. 4-6).

The box 8 also houses an upper guide or ramp 15 suitable for guiding by contact the bars 2 with the short guide pin 12.

The horizontal structure included in box 8 and connecting the lateral guides of the two uprights 6 is said cantilever 70.

The width of the guide 13 is such as to allow the passage of the bars with long pins 11 only; the bars 2 with short pins 12 continuing upwards following ramp 15, thus forming a proper changeover point 80.

The connector 50 is advantageously made of plastic, with better noise absorption qualities than those of metal.

With reference to the attached drawings and in particular to FIGS. 3-5 starting from a closed position of roller-door 5, the operation of the shutter is as follows: the toothed wheel 9, driven by the electric motor 17, meshes with the rack connecting-rod 3, thus moving the roller-door 5. During the manoeuvre of lifting the roller-door 5, the uppermost bar 2 leaves the upright 6 and is forced by the connector 50 to enter the lower guide 13, in virtue of the elongated form of the long pins 11 which interact through their outermost part with the upper edge of the guide 13 (cam coupling).

Said first bar 2 with long pin 11 runs along said guide 13 until it meets the first recess 14 which detains it in position.

The second bar 2, with the short end pin 12 according to the logic of alternation mentioned earlier, does not enter the guide 13 because its end pin does not have sufficient length, and rises towards the top of the box 8 thanks to the ramp 15, rotating around said first bar 2 as a result of the pivots of connecting-rod 3.

The subsequent third bar 2 with the long pin 11 enters the guide 13 until it collides with the first bar 2 which is detained by the first recess 14: said collision, caused by the lifting mechanism which continuously moves the bars 2 towards the inside of the box 8 (FIG. 4), brings about the exit from the first recess 14 of the first bar 2, which thus resumes its movement along the guide 13 until it stops inside a second recess 14.

In the meantime the third bar 2 travelling along the guide 13, which has collided with the first bar 2, stops inside the first recess 14 which earlier detained the first bar.

The subsequent fourth bar 2, with the short pin, follows the ramp 15, positioning itself at the top of the box 8.

Said procedure is repeated until the roller-door 5 is completely folded up inside the box 8.

Observing FIG. 2, we note that the roller-door 5 is raised by traction: the rack connecting-rods 3 are raised by a traction force without the risk of getting out of square.

The noise level is much reduced because the movement system does not include chain or belt systems running along the uprights, nor elastic detention means in the folding-up box.

The recesses 14 perform the same function as the elastic detention elements of the known art, but are much simpler, being not elastic but inelastic: the elastic means of the known detention means must anyway be assembled with precision and the springs calibrated. The springs also require maintenance.

The shutter according to the present invention specifies only some recesses 14 in the lower part of the guide 13, which can be easily made by deforming sheet metal. There is no need for maintenance.

The absence of idler pulleys at the bottom considerably increases the security of the shutter. The wheel 9 is usually at a height of more than 2 metres and is therefore substantially unreachable without ladders or similar.

Advantageously, the electric motor 17 is provided with a stop device 19 equipped with load or tension sensors (potentiometers), which interrupt the operation of the motor 17 in the event of variations in load compared with the normal operating parameters memorized in a control unit 100, due for example to bodies obstructing the standard operation of the grille: bodies trapped in the grille, bodies remaining under the grille during closure, bodies trapped at the top during raising, more generally hazardous situations for users.

Said stop device 19 is safer than known systems which make use of photocells arranged along the upright, because it is independent of the height at which the problem occurs, especially in the area at the top near the folding-box 8 where the motor 17 is installed with the relative gears.

The control unit 100 checks the efficiency of the shutter at every moment, monitoring among other things the stop device 19 and a possible lubrication system 101 equipped with a tank 102, a nozzle 103 and a feed pump operable on demand.

The control unit 100 is provided with means of transmitting and receiving data, so as to allow remote control of the roller-door.

The operating means 7 could be of other types, for example by belt, chain, levers, or any other type on the market.

1. A foldaway security shutter comprising a plurality of transversal elements articulated between them by means of connecting rods hinged by the extremities of said transversal elements, two lateral uprights inside which the extremities of the transversal elements and the connecting rods slide between a position of closure in which said transversal elements are outstretched along the uprights and an opening position in which the transversal elements are gathered in a superior box, and operation means of the transversal elements, characterized in that the box houses a horizontal inferior guide provided with a plurality of consecutive notches suitable for the temporary anelastic retainment of transversal elements.

2. The shutter according to claim 1, characterized in that said operation means are provided with a toothed wheel, operated by an electric motor, suitable for engaging the internal toothing of rack connecting rods causing the up and down operation of the transversal elements.

3. The shutter according to claim 1, characterized in that the operation means comprise a stop device provided with sensors suitable for monitoring load variations in respect to regular working operation parameters memorized in a control unit.

4. The shutter according to claim 1, characterized in that the transversal elements present alternatively extremity long pins and extremity short pins, the former ones entering by contact in the horizontal inferior guide, the latter ones following a superior draft, causing the folding of the shutter.

5. The shutter according to claim 1, characterized in that the upright and the inferior guide are connected by connectors made of plastic material.

6. The shutter according to claim 1, characterized in that it comprises a system of lubrication.

7. The shutter according to claim 1, characterized in that it comprises cleaning brushes inside the uprights.

8. A method of folding in a box with an horizontal guide of transversal elements connected by connecting rods of a foldaway security shutter, characterized in that it provides the temporary anelastic retainment of transversal elements in a plurality of consecutive notches obtained in the horizontal guide, a transversal element being removed from the notch in which it is retained by a following transversal element which occupies the notch left free by the removed transversal element which moves towards a subsequent notch of temporary anelastic retainment.
